(19) United States
(12) Patent Application Publication
(10) Pub. No.: US 2007/0033163 A1
(43) Pub. Date: Feb. 8, 2007

(54) Search and storage of media fingerprints

(75) Inventors: Michael A. Epstein, Spring Valley, NY (US); Raymond J. Krasinski, Suffern, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklij Philips Electronics N.V.

(21) Appl. No.: 10/557,979

(22) PCT Filed: May 24, 2004
(86) PCT No.: PCT/IB04/01826

§ 371 Date: Nov. 17, 2005

Related U.S. Application Data
(60) Provisional application No. 60/474,828, filed on May 30, 2003.

(51) Int. Cl. G06F 17/30; G06K 9/00

(52) U.S. Cl. 707/3; 382/100

(57) ABSTRACT

Recognizing that a variety of different fingerprints may correspond to the same dataset, the search of a database of fingerprints to find a match to a target fingerprint is performed with relaxed criteria for declaring a match between two fingerprints. By matching “similar”, but not “exact”, fingerprints, redundant fingerprints need not be stored for each dataset. When a new fingerprint is found, a first-in first-out (FIFO) strategy is used to allocate space in a limited memory-space to store the new entry.

This invention relates to the field of consumer electronics, and in particular to a method and system that facilitates an efficient search and storage of digital fingerprints.

U.S. patent application US 2002/0032864 A1, “CONTENT IDENTIFIERS TRIGGERING CORRESPONDING RESPONSES”, filed 14 May 2001 for Geoffrey B. Rhoads and Kenneth L. Levy, presents a variety of techniques that are commonly used to create one or more “fingerprints” based on the contents of a dataset, such as an audio or video file, and is incorporated by reference herein. The fingerprint of a dataset is commonly used to access ancillary information related to the dataset, such as an identification of the title of the dataset, the performing artist, the composer, the director, and so on. Additionally, the fingerprint of the dataset may be used to verify access rights to the dataset and/or to assess fees associated with such access. Other uses of an identifier of a dataset based on the contents of the dataset are common in the art.

Commonly used fingerprints associated with entertainment material, such as audio and video recording are intended to uniquely identify the recording, and as such, are of substantial length. For example, a 128-byte format for the fingerprint of professional/commercial audio recordings is common. A database of hundreds of thousands of such fingerprints can be expected to be used for uniquely identifying commercial audio recordings, and efficient searching techniques for large identifiers in large databases are required.

Memory for saving databases of fingerprints and corresponding ancillary information can also be expected to be included in consumer entertainment equipment, and efficient storing techniques for this information will also be required.

Further complicating the task of fingerprint searching and storage, a one-to-one correspondence between a fingerprint and a dataset may not exist. A fingerprint may be based on the entire contents of the dataset, or based on one or more select segments of the dataset. Because the fingerprint is based on the contents of the dataset, the sampling of the dataset to obtain a fingerprint may produce different fingerprints for the same dataset. A search of a database of fingerprints to find a match with a currently determined fingerprint often requires multiple searches through the database, based on alternative samples of the dataset, and/or a search through a database that contains multiple fingerprints for the same dataset.

Consider, for example, a database of songs, and a fingerprint creation scheme that provides an average of ten different fingerprints for the same song. The database can be constructed to contain the ten most frequently occurring fingerprints for each song, or it could be constructed to contain the single most likely fingerprint. When an as-yet-unknown dataset is sampled to produce a “search” fingerprint, it may or may not match a fingerprint in the database, either because this particular song is not included in the database, or because the song is in the database but the particular search fingerprint is not one of the fingerprints in the database for this song. When a match is not found, a new sample is typically obtained, and if a new search fingerprint is produced, this new fingerprint is used to search the database for a match. Having the ten most frequently occurring fingerprints for a song stored in the database increases the likelihood of a match being found quickly, but it also requires comparing the search fingerprint to ten-times as many stored fingerprints; storing only one fingerprint per song reduces the size of the database and the search-time for each search fingerprint, but increases the likelihood of having to perform multiple searches using different acquired fingerprints.

Because of the likelihood of multiple fingerprints corresponding to the same song, the need for efficient search and storage techniques exists even for relatively small databases, and is particularly crucial for large databases.

It is an object of this invention to provide a method and system that facilitates a search of a database based on fingerprints that exhibit variance. It is a further object of this invention to provide a method and system that facilitates efficient storage of a fingerprint database in a limited-size memory.

These objects and others are achieved by a search that allows for a range of variance about each fingerprint, and by the use of a first-in first-out storage strategy. Recognizing that a variety of different fingerprints may correspond to the same dataset, the search of a database of fingerprints to find a match to a target fingerprint is performed with a relaxed criteria for declaring a match between two fingerprints. By matching “similar”, but not “exact”, fingerprints, redundant fingerprints need not be stored for each dataset.

When a new fingerprint is found, a first-in first-out (FIFO) strategy is used to allocate space in a limited memory-space to store the new entry.

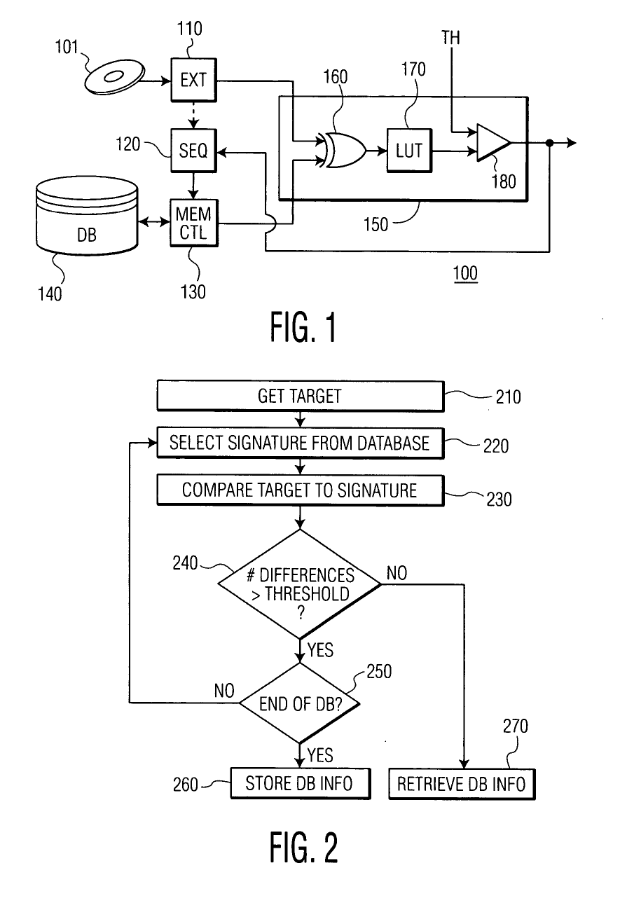

FIG. 1 illustrates an example block diagram of a search and storage system in accordance with this invention.

FIG. 2 illustrates an example flow diagram of a match-determining process in accordance with this invention.

Throughout the drawings, the same reference numeral refers to the same element, or an element that performs substantially the same function.

FIG. 1 illustrates an example block diagram of a search and storage system 100 in accordance with this invention. The system 100 includes a comparator 150 that is configured to compare a target fingerprint to select fingerprints from a database of fingerprints 140. An extractor 110 extracts the target fingerprint from a media 101, and a sequencer 120 selectively provides fingerprints from the database 140 for comparison with this target fingerprint.

In accordance with this invention, the comparator 150 is configured to determine a match between the target fingerprint and the database fingerprint based on the amount of difference between the fingerprints, and not merely whether a difference exists. That is, the comparator 150 is configured to declare a match between the target fingerprint and the database fingerprint even if some differences exist between them. In the general case, the comparator 150 includes a difference determinator 160 that identifies the differences between the fingerprints, and a quantifier 170 that determines a measure of the amount of difference, based on the identified differences.

In the example embodiment illustrated in FIG. 1, the difference determinator 160 comprises an exclusive-OR (XOR) device that identifies each differing bit of the signatures, and the quantifier 170 comprises a lookup table (LUT) that maps the bit differences to the quantitative measure. The difference determinator 160 and quantifier 170 may be configured to effect a comparison of entire fingerprints, or, they may be configured to sequentially effect comparisons of portions of the fingerprint, and accumulate a running sum of the difference measures. For example, the XOR device of the difference determinator 160 may be configured to compare each byte of the fingerprints to produce a difference-byte, and the lookup table of the quantifier 170 provides a count of the number of bit differences corresponding to each difference-byte. For example each of the difference-bytes 00000001, 00000010, 00000100, . . . 10000000 will map to a quantity value of “1”, indicating a one-bit difference. Difference bytes 00000011, 00000101, 00000110, . . . 10100000, 11000000 will map to a quantity value of “2”, indicating a two-bit difference, and so on. In such an embodiment, the quantifier 170 maintains a running sum of the quantity values from a lookup table for each difference-byte, to provide a cumulative measure of the amount of difference between the fingerprints, which in this example, is a count of the total number of bits that differ between the fingerprints.

Other methods of measuring or quantifying the amount of difference between two fingerprints will be evident to one of ordinary skill in the art in view of this disclosure. For example, if particular words within the fingerprint are more important or distinctive than other words in the fingerprint, the quantifier 170 may be configured to assign different weight to the quantitative measure that is determined for each word. In like manner, more differences may be allowable within some segments of the fingerprint than in other segments, and so on.

A comparator device 180 compares the quantitative measure of the differences from the quantifier 170 to a threshold value Th to determine whether a non-match is detected. If the measure of differences exceeds the threshold, a non-match is declared. As contrast to conventional devices, the threshold value of this invention is greater than zero, thereby allowing one or more differences to exist between the fingerprints without declaring a non-match. If the comparator 150 is configured to sequentially compare bytes or words, or other segmentations of the fingerprint, and the quantifier 170 provides a running total of the measure of differences, a non-match may be declared as soon as the running total exceeds the maximum.

The sequencer 120 is configured to control a memory controller 130 that extracts each fingerprint from the database 140 for comparison with the target fingerprint. The term database is used herein in the general sense, to include any collection of information that facilitates retrieval of the information. The database may be stored in one or more memory devices, which may be configured internal or external to the system 100, or both. In a straightforward embodiment, the sequencer 120 merely provides each fingerprint from the database 140 in a sequential manner, until a match is found by the comparator 150. In a more complex embodiment, the choice of each next fingerprint from the database 140 may be based on results provided by the comparator 150. For example, if the fingerprints are stored in the database 140 in some order or pattern, the comparator 150 may be configured to provide an indication of the differences between the last fingerprint from the database and the target fingerprint. In such an embodiment, the sequencer may be configured to sequentially search using a particular increment span that is dependent upon the indicated differences. For example, if substantial differences are noted, the sequencer may use a large increment span until fewer differences are noted.

Copending U.S. Patent Applicantion, “REORDERED SEARCH OF MEDIA FINGERPRINTS”, filed Dec. 19, 2002, for Michael Epstein and Raymond Krasinski, Attorney Docket US020591 (702895), discloses advantages that can be gained by storing fingerprints in a database using a re-ordering of bytes, compared to the conventional MSB-to-LSB byte-ordering, and is incorporated by reference herein. If the fingerprints are stored in a sorted order, either conventionally or as taught in this copending application, the sequencer 120 is configured to effect an ordered search of the database for the target fingerprint (as indicated by the dashed arrow between the fingerprint extractor 110 and the sequencer 120), using conventional sort-search techniques, such as a binary search based on the sign of the difference between the prior fingerprint from the database 140 and the target fingerprint. Because the comparator 150 allows differences to exist while still declaring a match between two fingerprints, a sorted search by the sequencer 120 is modified compared to a conventional sorted search. If a match is found, the sequencer 120 terminates further searching, as in a conventional sorted search. However, if a match is not found among the samples that the sequencer 120 selects based on the particular sorted-search algorithm that is used, an exhaustive search of the database 140 may be required to assure that a near-miss fingerprint (i.e. a fingerprint that differs from the target fingerprint by less than the threshold amount) does not exist in the database 140.

Optionally, when it is determined that a match cannot be found in the database 140, the sequencer 120 is configured to store the fingerprint, and ancillary data, in the database 140, via the memory controller 130. In a preferred embodiment of this invention, the controller 130 is configured to effect a first-in first-out strategy for adding new fingerprints, in the event that the database 140 is full. Other techniques for determining which information to remove to make room for new information will be evident to one skilled in the art, including prompting the user to manually delete a fingerprint to make room for the new fingerprint.

FIG. 2 illustrates an example flow diagram of a match-determining process in accordance with this invention. At 210, the target fingerprint is received, and the loop 220-250 commences. At 220 a fingerprint is selected from the database, and at 230, this fingerprint is compared to the target fingerprint. As noted above, this invention allows a match to be determined between two fingerprints even if differences exist between the fingerprints. In this example embodiment, the quantitative measure that is used to evaluate the differences between signatures is the number of differences observed, such as the number of bits that differ between the signatures, or the number of words that differ between the signatures, and so on.

If, at 240, the number of differences between the signatures is greater than a threshold value, a non-match is asserted, and another signature is selected from the database, at 220, except if all of the entries in the database have been determined to not match, at 250. If all of the entries are determined to not-match, at 250, the process terminates at 260, optionally by allowing the user to store the new information corresponding to the target fingerprint to the database.

If, at 240, the number of differences between the signatures is not greater than the threshold, a match is declared, and the ancillary information corresponding to the matching signature is retrieved, at 270.

Note, however, that because a ‘near-miss’ may be identified as a match to the target fingerprint, the near-miss may not, in fact, correspond to the target. Not illustrated, if the retrieved information does not actually correspond to the target material (101 in FIG. 1), the user is provided the option to store the new information corresponding to the target fingerprint to the database as an addition or a replacement.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the aforementioned threshold value is presented herein as a static value. One of ordinary skill in the art will recognize that ‘learning’ techniques can be applied to the system 100 to dynamically modify the threshold value to improve the performance of the system. For example, the threshold can be modified based on the observed variances among signatures for the same material. If the user repeatedly identifies a non-correspondence between matched-fingerprints and targets, as discussed in the immediately prior paragraph, for example, the system 100 could be configured to reduce the threshold value, either automatically, or with the user's approval or initiation. In like manner, the threshold value may be dynamically modified based on the size of the database 140, or a classification of the contents of the database 140. In like manner, if the fingerprints are classified or ordered, different threshold values may be used for different classifications or orders. These and other system configuration and optimization features will be evident to one of ordinary skill in the art in view of this disclosure, and are included within the scope of the following claims.

1. A system for searching a plurality of fingerprints for a select fingerprint that corresponds to a target fingerprint, comprising:
a comparator that is configured to compare a given fingerprint to the target fingerprint, and to identify the given fingerprint as the select fingerprint when a match is determined, and,
a sequencer that provides the given fingerprint from the plurality of fingerprints to the comparator,
wherein
the comparator is configured to determine the match based on a quantitative measure associated with differences between the given fingerprint and the target fingerprint, such that the match can be determined when one or more differences exist between the given fingerprint and the target fingerprint.

2. The system of claim 1, wherein
the quantitative measure is dependent upon a count of the differences between the given fingerprint and the target fingerprint.

3. The system of claim 1, wherein
the comparator is configured to determine the match by comparing the quantitative measure to a threshold value.

4. The system of claim 3, wherein
the system is further configured to dynamically adjust the threshold value based on prior determinations of matches.

5. The system of claim 1, wherein
the comparator includes
a difference determinator that is configured to identify the differences between the given fingerprint and the target fingerprint; and
a quantifier, operably coupled to the difference determinator, that is configured to determine the quantitative measure based on the identified differences.

6. The system of claim 5, wherein
the difference determinator includes an exclusive-or function.

7. The system of claim 6, wherein
the quantifier includes
a lookup table that provides a quantity value based on the identified differences, and
the quantifier determines the quantitative measure based on the quantity value.

8. The system of claim 5, wherein
the quantifier includes
a lookup table that provides a quantity value based on the identified differences, and
the quantifier determines the quantitative measure based on the quantity value.

9. The system of claim 1, further including
a memory controller that is configured to store the target fingerprint as one of the plurality of fingerprints when the match is not determined.

10. The system of claim 9, wherein
the memory controller is configured to use a first-in first-out strategy to store the target fingerprint in a memory.

11. A system for searching a plurality of fingerprints for a select fingerprint that corresponds to a target fingerprint, comprising:
a comparator that is configured to compare a given fingerprint to the target fingerprint, and to identify the given fingerprint as the select fingerprint when a match is determined,
a sequencer that provides the given fingerprint from the plurality of fingerprints to the comparator,
a memory that is configured to contain the plurality of fingerprints, and
a memory controller that is configured to store the target fingerprint as one of the plurality of fingerprints in the memory when the match is not determined, using a first-in first-out (FIFO) strategy.

12. The system of claim 11, wherein
the plurality of fingerprints are stored in the memory in a sorted order.

13. The system of claim 12, wherein
the comparator is configured to determine the match when a number of differences between the given fingerprint and the target fingerprint is less than a threshold value that is greater than one, thereby allowing the match to be determined when one or more differences exist between the given fingerprint and the target fingerprint.

14. A method of searching a plurality of fingerprints for a matching fingerprint that corresponds to a target fingerprint, comprising:
selectively comparing a given fingerprint from the plurality of fingerprints to the target fingerprint to determine whether the given fingerprint is the matching fingerprint,
wherein
the given fingerprint is determined to be the matching fingerprint when a number of differences between the given fingerprint and the target fingerprint is less than a threshold value that is greater than one,
thereby allowing the given fingerprint to be determined to be the matching fingerprint when one or more differences exist between the given fingerprint and the target fingerprint.

15. The method of claim 14, wherein
comparing the given fingerprint to the target fingerprint includes:
identifying differences between the given fingerprint and the target fingerprint, and
quantifying the number of difference based on the identified differences.

16. The method of claim 15, wherein
identifying the differences includes effecting an exclusive-or of the given fingerprint and the target fingerprint.

17. The method of claim 16, wherein
quantifying the number of differences includes accessing a lookup table to obtain a quantity value based on the identified differences.

18. The method of claim 17, wherein
quantifying the number of differences includes accessing a lookup table to obtain a quantity value based on the identified differences.

19. The method of claim 14, further including
storing the target fingerprint as one of the plurality of fingerprints when the matching fingerprint is not found in the plurality of fingerprints.

20. The method of claim 19, wherein
storing the target fingerprint includes applying a first-in first-out strategy to store the target fingerprint in a limited-size memory.
